(19) United States
(12) Patent Application Publication
(10) Pub. No.: US 2006/0256092 A1
(43) Pub. Date: Nov. 16, 2006

(54) RECONFIGURABLE INTERACTIVE INTERFACE DEVICE INCLUDING AN OPTICAL DISPLAY AND OPTICAL TOUCHPAD THAT USE AEROGEL TO DIRECT LIGHT IN A DESIRED DIRECTION

(76) Inventor: Daniel J. Lee, Salt Lake City, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/383,099

(22) Filed: May 12, 2006

Related U.S. Application Data
(60) Provisional application No. 60/680,205, filed on May 12, 2005.

(51) Int. Cl. G09G 5/00

(52) U.S. Cl. 345/173

(57) ABSTRACT

An optical display that can also function as an optical touchpad, wherein a substrate is used as a light guide to provide a plurality of paths for light to travel and arrive at a display region, wherein a unique image is selectively made visible in the display region by choosing to transmit light to the display region through one of the plurality of paths, and wherein optical sensors are also associated with the display region to thereby enable detection of an object that is in contact with at least one display region.

### CROSS REFERENCE TO RELATED APPLICATIONS

This document claims priority to, and incorporates by reference all of the subject matter included in the provisional patent application docket number 3246.CIRQ.PR, having Ser. No. 60/680,205 and filed on May 12, 2005.

### BACKGROUND OF THE INVENTION

1. Field of the Invention

This invention relates generally to input and display devices. More specifically, the present invention is an optical input and display device, wherein light is injected from different directions into a substrate, wherein the image that is displayed depends upon the direction from which the light is being injection. Accordingly, a desired image is visible at a display location by causing light to be directed to the display location along a selected path and associated angle of illumination. Photo sensors can also be disposed in the substrate to thereby detect the presence of a finger or other object at a display location.

2. Description of Related Art

It is desirable to be able to combine display and input devices to thereby enable interaction. For example, a touchscreen on a personal digital assistant (PDA) is a common example of a ubiquitous portable electronic appliance that utilizes this combination of technologies. A typical PDA utilizes a relatively transparent touch sensitive screen that is disposed over an LCD display. The touch sensing technology determines the location at which pressure is being applied to the touch sensitive surface of the LCD display. The location that the touch sensitive screen is being touched is then correlated to the image being shown in the LCD display. An appropriate response is then activated by the PDA.

For example, the LCD display is showing a keyboard. When the user touches the screen above a particular letter, the PDA can cause that letter to be entered into a typing area of the LCD display.

Touch-sensitive displays are not limited to pressure sensing technology, but can also include such technology as capacitance-sensitive sensors. Various techniques are currently being developed to dispose capacitance-sensitive electrode grids on top of an LCD display. The electrode grids are being manufactured such that the electrodes are essentially transparent to the user, and thus do not interfere with viewing of whatever image is being shown on the LCD display.

It would be a departure from the state of the art of interactive displays such as touch-sensitive LCD screens to provide an interactive display system that uses a combined optical display and optical touchpad, wherein both the display and touchpad use aerogel to bend light in desired directions, wherein the optical display can show a plurality of different images in a same display region by simply sending light to a display region from different directions, and wherein optical sensors use the same light paths to detect the presence of an object on the display regions.

### BRIEF SUMMARY OF THE INVENTION

It is an aspect of the present invention to provide an optical touchpad.

It is another aspect of the invention to provide an optical display.

It is another aspect to combine an optical touchpad and an optical display into a single device.

It is another aspect to provide the optical display that utilizes light injected into a substrate to generate a unique character in a display region, depending upon the angle that light is delivered to the display region.

It is another aspect to provide optical sensors that can detect a change in light at specific display regions, and thereby determine the presence of an object at specific display regions.

The present invention is directed to an optical display that can also function as an optical touchpad, wherein a substrate is used as a light guide to provide a plurality of paths for light to travel and arrive at a display region, wherein a unique image is selectively made visible in the display region by choosing to transmit light to the display region through one of the plurality of paths, and wherein optical sensors are also associated with the display region to thereby enable detection of an object that is in contact with at least one display region.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a profile cut-away view of one embodiment of the layers that are made in accordance with the principles of the present invention.

FIG. 2 is a close-up cut-away view of a surface feature indicated by circle A in FIG. 1.

FIG. 3 is a perspective view of the shape of a single surface feature 20 as it would appear if it were lifted straight out of the light guide 10.

FIG. 4 is a birds-eye view of the surface 32 of a light guide 10, showing only one example of how surface features might be disposed in a single display region to illuminate more than one symbol.

FIG. 5 is provided to illustrate which surface features were properly oriented with respect to the light from the light guide 10 such that the light could be bent towards an observer above the optical display.

FIG. 6 is a front view of a mobile telephone having a first keyboard displayed thereon that is configured for use with a numeric keypad.

FIG. 7 is the same front view of the mobile telephone of FIG. 6, but reconfigured with a different alphabetical keyboard, such as a QWERTY keyboard.

FIG. 8 is a portion of an optical display shown in a perspective view to illustrate the use of LEDs to transmit light to display regions.

FIG. 9 is a portion of the optical display of FIG. 8 that now includes optical sensors at the light insertion points so that the presence of a finger on a display region can be detected.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The present invention combines an optical touchpad and an optical display. While this combination of features is available in any LCD display that has a touch-sensitive surface, the display and the touch-sensing system are completely separate devices. In contrast, the present invention essentially uses the same hardware.

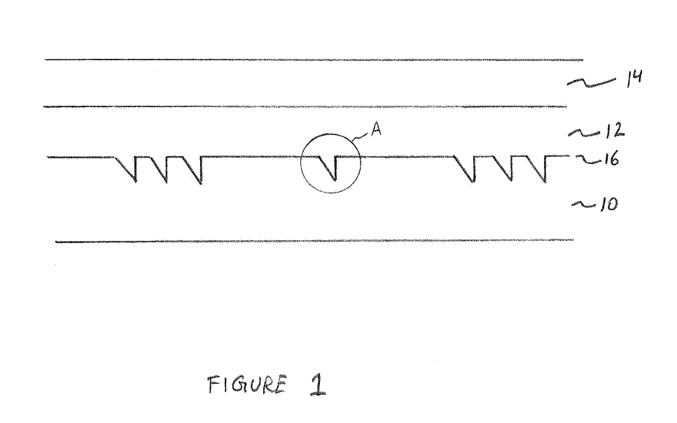

Beginning with the design of the optical display, FIG. 1 is provided to illustrate the layers in a cross-sectional profile view. This first embodiment illustrates a light guide layer 10, a low index of refraction layer 12, and a protective layer 14.

The light guide 10 is any substrate material that functions as a light guide. A light guide is any path for light that enables the light to travel substantially within the confines of the path. The transparent substrate 10 can be comprised, for example, of Mylar™, Lexan™, polycarbonate, or any material that enables the substrate material to function as a light guide. A second aspect of the light guide is that it should be comprised of a material having a high index of refraction. However, other non-plastic materials may also be found to be suitable as light guides and should be considered to be within the scope of the embodiments of the present invention.

When light is passed through the light guide, it is desirable to direct as much light as possible along a desired path. The more light that is directed outward to the eye of an observer, the brighter the optical display will be. If the light guide 10 has a high index of refraction, it is possible to keep the light within the light guide by taking advantage of the critical angle for refraction. When light is passing from a material with a higher index of refraction to a material having a lower index, there is an angle at which light will not pass into the material having the lower index of refraction. At this critical angle, the light will be reflected at the surface between the two materials. At all angles greater than the critical angle, light will also be reflected off the interface of the two materials, just like a mirror.

In the first embodiment shown in FIG. 1, the low index of refraction layer 12 serves a first purpose of keeping the light within the light guide 10. Light is reflected back into the light guide 10 when light reaches the interface 16 at any angle greater than the critical angle.

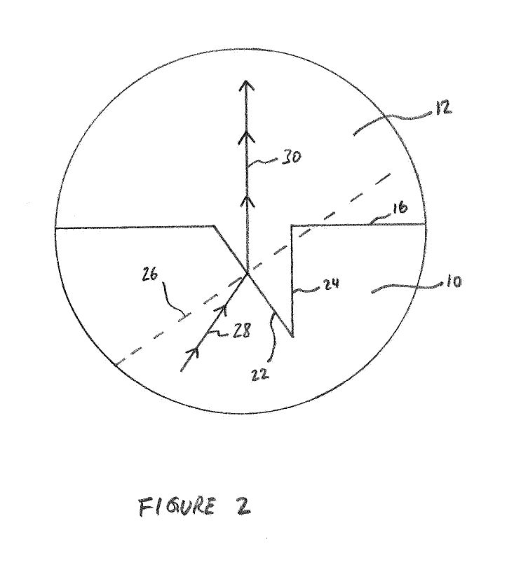

The low index of refraction layer 12 also serves another purpose, as shown in FIG. 2. FIG. 2 is provided to illustrate an important aspect of the optical display. Specifically, diffraction patterns created in the light guide 10 enable light to escape from the light guide in desired locations. A diffraction pattern is any surface feature 20 that can be created at the interface 16 that enables light to escape. But then it is necessary to direct the light to an observer. This is the second function of the low index of refraction layer 12.

In the first embodiment, one possible surface feature 20 that enables light to escape is illustrated in a close-up view of a portion of a diffraction pattern in FIG. 2. FIG. 2 is a close-up of the surface feature 20 as indicated by circle A in FIG. 1.

The surface feature 20 is an indentation in the surface of the light guide 10. Notice that the surface feature 20 is in the shape of a sawtooth, having a slanted side 22 and a vertical side 24 with respect to a surface of the light guide 10. A dotted line 26 (to be referred to hereinafter as the “normal”) is shown as being perpendicular to the slanted side 22.

Light is delivered to the surface feature 20 along a path that enables at least a portion of the light to strike the slanted edge along path 28. When light is traveling from a high index of refraction material (light guide 10) to a low index of refraction material (low index of refraction layer 12), the light increases in velocity, and bends away from the normal 26. A possible path of the light after passing into the low index of refraction layer 12 is shown as path 30. Snell's law can be used to determine the angle at which a beam of light bends, relative to an initial angle and the index of refraction of the light guide 10 and the low index of refraction layer 12.

Ideally, the low index of refraction layer 12 should have an index of refraction that is as close to unity as possible. Light in a vacuum has an index of refraction of 1.00. Air has an index of refraction of refraction that is very nearly 1.00. Therefore, the low index of refraction layer 12 is trying to function as an air gap. But the gap between the protective layer 14 and the light guide 10 cannot be air because a solid material is needed between the light guide and the protective layer. Thus, the gap must be filled with a solid having the lowest possible index of refraction, or the light leaving the surface feature 20 will not be directed to an observer.

The protective layer 14 will most likely be a material such as glass. Glass has an index of refraction that is very near that of the light guide 10, which would not enable the light to be directed along path 30. Thus, the low index of refraction layer between the light guide 10 and the protective layer 14 bends the light so that it is directed along the path 30. In effect, the light is being directed along a path that is generally perpendicular to the length of the light guide 10, and directed to an observer of the optical display. Note that because the light travels along path 30, the light is entering and exiting perpendicular to the protective layer 14. Accordingly, the protective layer 14 does not alter path 30 of the light.

One solid substance that can provide an extremely low index of refraction for the low index of refraction layer 12 is known as aerogel. Aerogel has been developed in many different configurations, depending upon the properties that are needed. Aerogel is the lightest and lowest-density solid known to exist, is composed of 90-99.8% air with typical densities of 3-150 mg/cm³, yet can theoretically hold 500 to 4,000 times its weight in applied force. Aerogel can have surface areas ranging from 250 to 3,000 square meters per gram, meaning that a cubic inch of aerogel flattened-out would have more surface area than an entire football field.

Aerogel is a remarkable thermal insulator because it almost nullifies three methods of heat transfer (convection, conduction or radiation). It is a good convective inhibitor because air cannot circulate throughout the lattice. Silica aerogel is a good conductive insulator because silica is a poor conductor of heat. (Metallic aerogel, on the other hand, is a better heat conductor.) Carbon aerogel is a good radiative insulator because carbon absorbs the infrared radiation that transfers heat. The most insulative aerogel is silica aerogel with carbon added to it.

One property of particular importance to the present invention is that aerogels have an index of refraction that is typically 1.00 to 1.05, which is far lower than any other solid. However, it is within the scope of the present invention that any other material that has an index of refraction that is capable of bending light to the desired path when leaving the light guide 10 can be substituted for aerogel.

It is noted that it may be necessary to secure the layers 10, 12, 14 in place with more than simple applied pressure. Any proper means of securing the layers 10, 12, 14 together may be used, as long as it causes minimal interference with the functions of the layers. For example, an appropriate adhesive may need to be inserted between the layers 10 and 12, between layers 12 and 14, or between layers 10, 12 and 14. The adhesive should cause minimal interfere with the bending of light that occurs at interface 16, or the non-bending of light at the interface between the low index of refraction layer 12 and the protective layer 14. Any adhesive should also pass as much of the light as possible, so transparency of the adhesive is important to a bright optical display.

Now that it is possible to direct light that is traveling through the light guide 10 in a direction that is perpendicular to its surface, it can be explained how the present invention can display desired information when operating as an optical display.

In order to be able to display more than one symbol at essentially the same location, it is necessary to better understand how the light guide 10 functions with respect to the surface features 20.

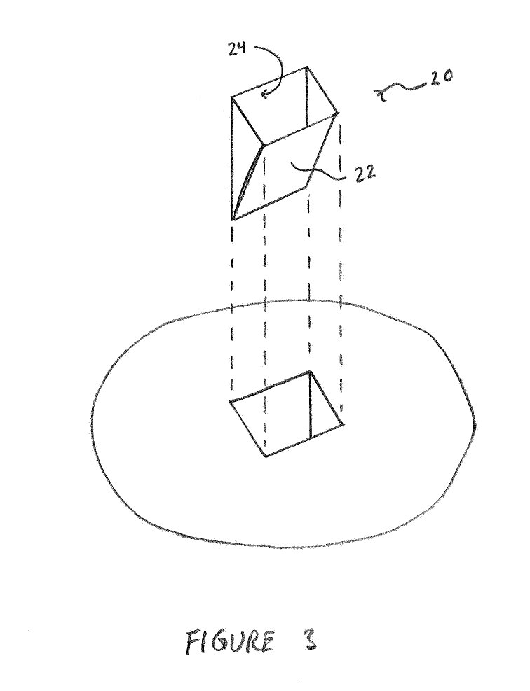

FIG. 3 is a perspective view of the shape of a single surface feature 20 as it would appear if it were lifted straight out of the light guide 10, with the vertical side 24 and the slanted side 22 being indicated.

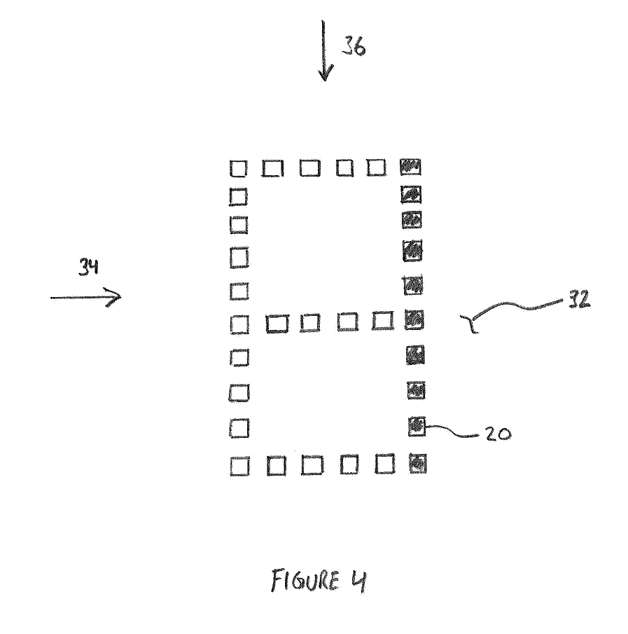

FIG. 4 is provided as a birds-eye view of the surface 32 of a light guide 10. It can be assumed that the low index of refraction layer 12 and the protective are also disposed above the light guide 10. The surface 32 is covered with a plurality of surface features 20. The surface features 20 are oriented so that when light is directed through the light guide 20 to the surface features from a first direction 34 or from a second direction 36, only those surface features that are oriented correctly will direct light outwards from the surface 32. It should be recognized that it is not possible to determine which way the surface features 20 are oriented from this birds-eye view unless the slanted side 22 could be seen. Nevertheless, only those surface features 20 that are oriented properly with respect to incoming light from the light guide 10 will be able to bend the light towards an observer. In FIG. 4, the number “1” is illuminated when the light is directed to the surface features 20 from direction 36.

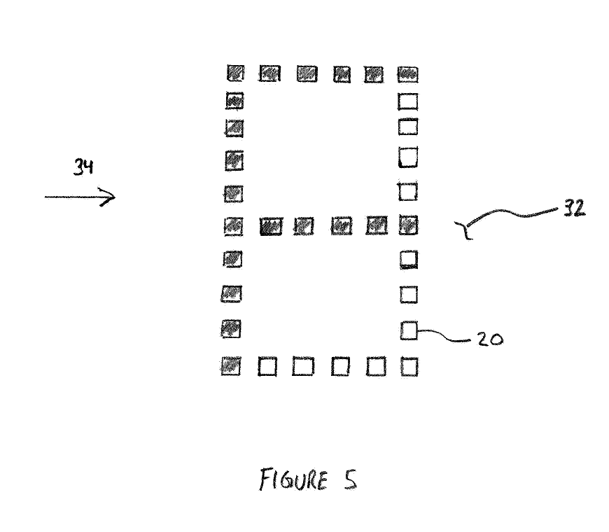

FIG. 5 is provided to illustrate which surface features were properly oriented with respect to the light from the light guide 10 such that the light could be bent towards an observer above the optical display. Different surface features 20 are illuminated when the light is directed from direction 34. Note that there is some overlap in illuminated surface features 20. This is done to illustrate the fact that surface features 20 will be very small and appear to overlap. It should also be understood that this is only an example. The size of the surface features 20 has been significantly exaggerated for illustration purposes only. Because the actual surface features 20 are extremely small with respect to the naked eye, they have been made larger for illustration purposes only.

The small size of the actual surface features 20 thus makes it apparent why a plurality of different symbols can be displayed at what appears to be the same location. It is because the actual surface features 20 can be located so close to each other. Surface features 20 can also be interspersed among the surface features of other symbols. This close proximity and/or interspersing of the surface features 20 makes the symbols to appear to be in the same location.

Consider the example of an optical display that is capable of displaying different symbols at the same location. The optical display is reconfigurable by simply changing the path that light is traveling through the light guide 10, and thereby creating different modes of operation.

In a first mode of operation, the optical display could show a numeric keypad, such as a keypad found on a mobile telephone. Accordingly, the keypad would include other keys such as the # symbol and the * symbol, as well as keys for navigation and selection. An example of such a keypad is illustrated in FIG. 3.

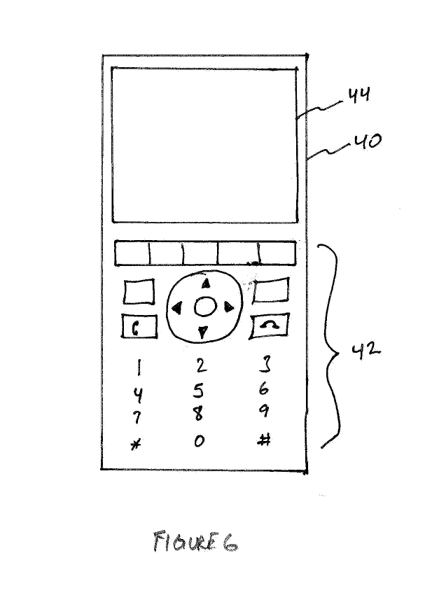

In FIG. 6, a mobile telephone 40 is shown having keypad 42 and LCD display 44. The keypad 42 is shown having the typical number keys 0-9, the *, the #, a navigation wheel, a call button, a disconnect call button, and other buttons as desired. What should be understood is that everything shown on the keypad 42, even the lines that are outlining the buttons, can all be generated using the principles of the first embodiment. Thus, the surface of the keypad can be a completely smooth and unbroken layer of transparent material, such as glass or plastic. The present invention is used to direct light to surface features 20 that are positioned such that when light escapes from them and is directed perpendicular to the light guide 20 and the protective layer 14, what is displayed is the outline of buttons and any numbers, letters and words that need to be shown that form the keypad 42.

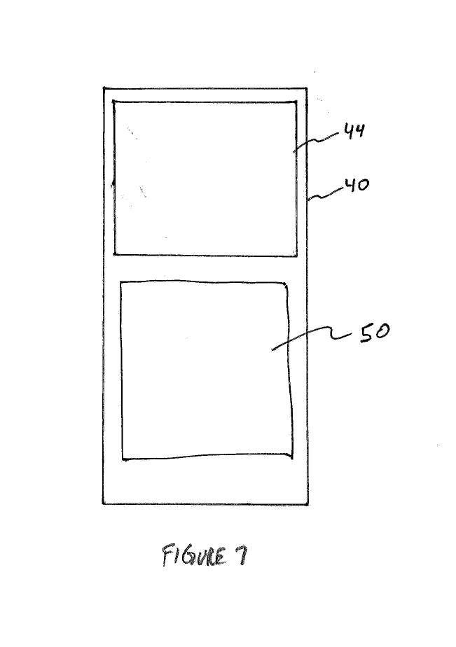

In a second mode of operation shown in FIG. 7, a completely different layout can be displayed in virtually the same location as the buttons shown in FIG. 6. Consider a QWERTY keyboard 50 layout. The individual letters and the outline of the keys are not shown, but are disposed within the area 50.

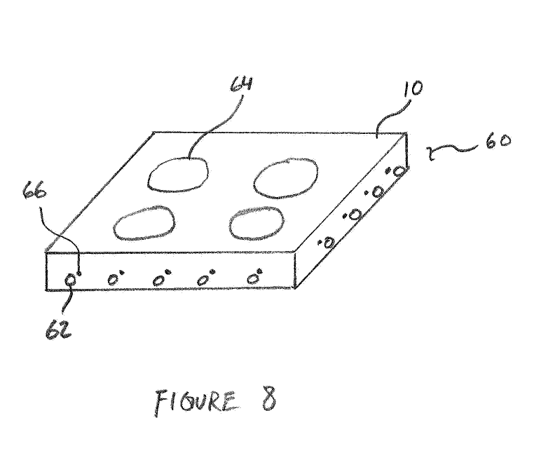

A portion of an optical display 60 is shown in a perspective view in FIG. 8. The first embodiment of the present invention transmits light into the light guide 10 using a plurality of light emitting diodes 62 (LEDs). In the first embodiment, each LED 62 transmits light to cause a unique symbol to be displayed. More than one LED 62 can direct light to a particular display region 64 on the light guide 10. Because the light from each LED 62 arrives from a different angle, only those surface features that are oriented properly with respect to the arriving light will bend light to an observer.

The light from LEDS 62 is selectively transmitted into the light insertion points 66. Each of the light insertion points 66 is a unique path for light through the light guide 10 to one of the plurality of display regions 64. Light from an LED 62 that is transmitted into one of light insertion points 66 travels along a unique path through the light guide 10. Light does not escape from the light guide 10 because the critical angle reflects the light back into the light guide 10. Once light from an LED 62 reaches one of plurality of display regions 64, it is necessary to cause the light to escape from the display region 64.

In the first embodiment, the light itself was visible through the protective layer 14. However, in a second embodiment, it is envisioned that a holographic image can be illuminated by the light. The holographic image can be disposed, for example, in or on the low index of refraction layer 12, and in or on the protective layer 14.

It is known that holographic images depend on illumination from specific directions. Accordingly, it is also an aspect of the present invention that the light being directed by the low index of refraction layer 12 might also be modified so that it is not necessarily directly perpendicular to the light guide 10. In other words, the light may be directed at angle so as to illuminate particular holographic images.

Illuminating selected LEDs 62 will cause a display region 64 to be illuminated with different diffraction patterns. If each diffraction pattern is embossed uniquely, one single display region 64 will be capable of displaying as many symbols as can be created in unique diffraction patterns at the display region.

It is another embodiment that multiple LEDS 62 may simultaneously be illuminated and direct light to the same display region 64, thereby causing multiple diffraction patterns and/or holographic images to be illuminated at the same time.

It is another embodiment that one LED 62 might simultaneously direct light to multiple display regions 64. However, in another embodiment, it is envisioned that one LED 62 might be directed to only illuminate a portion of a display region 64. Thus, it may require a plurality of different LEDs 62 directing light to a single display region 64 to fully illuminate a symbol therein.

The description above has focused on creating an optical display. However, the same light guide 10, low index of refraction layer 12 and protective layer 14 can also be used to create an optical touchpad that can determine where a user is, for example, placing a finger on the surface thereof.

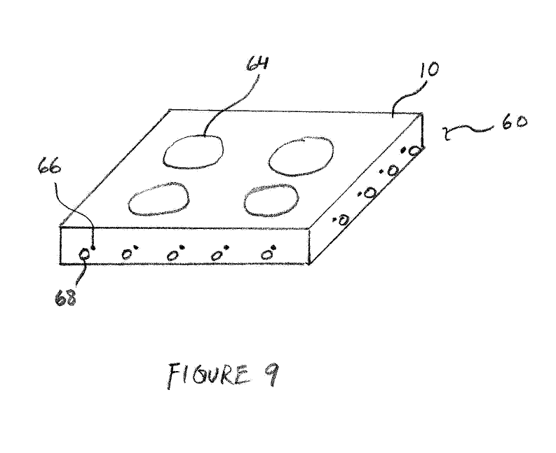

Consider in FIG. 9 the portion of the optical display 60 that was shown in FIG. 8. The optical display 60 can also function as an optical touchpad. The LEDs 62 are now replaced with optical sensors 68 disposed at each of the light insertion points 66. The light guide 10 transmits light along selected paths. These paths will direct whatever ambient light is being received at the display regions 64 to the light insertion points 66. A change in the amount of light being received by the optical sensors 68 is indicative of the presence of an object that is blocking ambient light.

The detection of an object on a display region 64 will be detected by all of the optical sensors 68 that are positioned at light insertion points 66 that direct light from an LED 62 to a particular display region 64. Thus, in this third embodiment, there will likely be, but are not required to be, multiple optical sensors 68 that can confirm the presence of an object at any particular display region 64. Accordingly, each of the display regions 64 is able to function, for example, as a button that can be touched and detected when the optical display 60 is functioning in the optical touchpad mode.

In this third embodiment, it is important to know that an optical display mode and an optical touchpad mode can function simultaneously. As long as there is at least one light path from a light insertion point 66 to a display region 64 that is not being illuminated by its associated LED 62, an optical sensor 68 can be used to detect the presence of a pointing object.

It is noted that when a display region 64 is being both illuminated by at least one LED 62 and being touched by a pointing object, such as a finger, that the variation in light being received by an optical sensor 68 may not be a decrease in ambient light, but some other recognizable change. Accordingly, whatever change in light is detectable by the optical sensors 68 should be considered as the signature or indicator of the presence of the pointing object.

With an understanding of how the present invention functions as an optical display and as an optical touchpad, there are many useful applications of this technology, only a few of which can be mentioned. These applications include any system that can use an interface that can be completely reconfigured on-the-fly. In general, a layout of buttons or controls can be changed at the touch of a single button. The circuitry for detecting a finger or other pointing object on the optical touchpad is always in place, as are the LEDs 62 that can instantly change what symbols are being displayed in display regions 64.

There are many applications of the optical display and optical touchpad technology as taught by the present invention. For example, in one embodiment, signal lights on a vehicle such as brake lights and turning signals can be replaced with an optical display of the present invention. But not only could the embodiment direct light outwards from a large display region, specific images could also be displayed. Furthermore, a plurality of different images could be displayed in the same display region, depending on which LEDs 62 were selected to illuminate the display regions 64.

In another embodiment, any device that may require multiple input interfaces can use the present invention. While a mobile telephone was already mentioned, it was not mentioned that the layout of the mobile telephone might be completely customizable so that a user's preferences on keymat layout might change the user's interface. Other devices that can take advantage of multiple interface arrangements include, but should not be considered limited to, a PDA, a computer keyboard, any portable electronic appliance, especially those where space is at a premium such as cameras and camcorders. Another application of the present invention is for a game controller. In a first mode, the game controller might emphasize or only display movement controls, but would automatically switch to a combat mode display when engaged in a fight. These are only a few examples of applications and devices, and should not be considered limiting.

Another important aspect of the present invention is power consumption. The energy savings of the embodiments of the present invention are significant. The present invention makes it possible to replace incandescent and even fluorescent bulbs in some applications with low power-consuming LEDS 62. LEDs 62 also have the advantage of being able to burn for many times longer than incandescent and fluorescent bulbs.

It should also be known that FIG. 1 only shows one possible arrangement of layers for an optical display and optical touchpad device. The number of layers may be altered. The composition of the layers may be altered depending upon the application of the embodiment. What is important is that the embodiments of the present invention are directed to the concept of enabling light to be directed to a display region, and arriving at the display region from a very specific angle. Also, multiple diffraction patterns are embedded into the display region. The diffraction patterns are created in such a way, known to those skilled in the art, which enables each diffraction pattern to be displayed only when light strikes the diffraction pattern from a specific angle or direction. Thus, a plurality of different symbols can be illuminated individually or simultaneously to display the desired image.

It is another aspect of the present invention that it is possible to create an optical display that does not include any of the components that enable the device to also function as an optical touchpad. Likewise, it is possible to create an optical touchpad that does not include any of the components that enable the device to also function as an optical display. Obviously, many of the elements are shared components, such as the light guide, the low index of refraction layer, and the protective layer. Nevertheless, only the optical display requires the LEDs, while only the optical touchpad requires the optical sensors.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. An interface device including an optical display that can also be used as an optical touchpad, said interface device comprised of:
a light guide for directing light along a plurality of different light paths;
at least one surface feature disposed in a surface of the light guide, wherein the surface feature enables light to enter and escape from the light guide;
a light bending layer disposed against the surface of the light guide, for bending light that enters and exits the at least one surface feature;
a plurality of light insertion points that enable light to be injected into the light guide;
a plurality of light sources, one light source for each of the plurality of light insertion points; and
a plurality of optical sensors, one optical sensor disposed at each of the light insertion points.

2. The interface device as defined in claim 1 wherein the interface device further comprises a protective layer disposed over the light bending layer, wherein the protective layer minimally affects a direction of light that enters or exits the at least one surface feature.

3. The interface device as defined in claim 2 wherein the at least one surface feature is further comprised of a plurality of surface features that form at least part of a symbol.

4. The interface device as defined in claim 3 wherein the plurality of surface features are further comprised of a diffraction pattern.

5. The interface device as defined in claim 2 wherein the light bending layer is further comprised of a low index of refraction material that directs light from the light guide generally perpendicularly outward from the surface thereof.

6. The interface device as defined in claim 5 wherein the low index of refraction material is further comprised of an aerogel.

7. The interface device as defined in claim 2 wherein the plurality of light sources is further comprised of a plurality of light emitting diodes (LEDs).

8. The interface device as defined in claim 2 wherein the plurality of optical sensors is further comprised of an optical sensor that detects variation in light intensity delivered from the at least one surface feature, through the light guide, and to at least one of the plurality of optical sensors at a light insertion point.

9. The interface device as defined in claim 2 wherein the interface is further comprised of at least one holographic image, wherein the holographic image is made visible when light from at the at least one surface feature illuminates the holographic image from a specific direction.

10. The interface device as defined in claim 2 wherein the interface is further comprised of a switch that enables the interface device to switch between displaying a first display and a second display.

11. A reconfigurable optical display, said optical display comprised of:
a light guide for directing light along a plurality of different light paths;
at least one surface feature disposed in a surface of the light guide, wherein the surface feature enables light to enter and escape from the light guide;
a light bending layer disposed against the surface of the light guide, for bending light that enters and exits the at least one surface feature;
a plurality of light insertion points that enable light to be injected into the light guide;
a plurality of light sources, one light source for each of the plurality of light insertion points.

12. The interface device as defined in claim 11 wherein the optical display is further comprised of a protective layer disposed over the light bending layer, wherein the protective layer minimally affects a direction of light that enters or exits the at least one surface feature.

13. The interface device as defined in claim 12 wherein the at least one surface feature is further comprised of a plurality of surface features that form at least part of a symbol.

14. The interface device as defined in claim 13 wherein the plurality of surface features are further comprised of a diffraction pattern.

15. The interface device as defined in claim 12 wherein the light bending layer is further comprised of a low index of refraction material that directs light from the light guide generally perpendicularly outward from the surface thereof.

16. The interface device as defined in claim 15 wherein the low index of refraction material is further comprised of an aerogel.

17. The interface device as defined in claim 12 wherein the plurality of light sources is further comprised of a plurality of light emitting diodes (LEDs).

18. The interface device as defined in claim 12 wherein the interface is further comprised of at least one holographic image, wherein the holographic image is made visible when light from at the at least one surface feature illuminates the holographic image from a specific direction.

19. The interface device as defined in claim 12 wherein the interface is further comprised of a switch that enables the interface device to switch between displaying a first display and a second display.

20. An optical touchpad, said optical touchpad comprised of:
a light guide for directing light along a plurality of different light paths;
at least one surface feature disposed in a surface of the light guide, wherein the surface feature enables light to enter and escape from the light guide;
a light bending layer disposed against the surface of the light guide, for bending light that enters and exits the at least one surface feature;
a plurality of light detection points that enable light traveling along specific paths within the light guide to exit therefrom; and
a plurality of optical sensors, one optical sensor disposed at each of the light insertion points.

21. The interface device as defined in claim 20 wherein the interface device further comprises a protective layer disposed over the light bending layer, wherein the protective layer minimally affects a direction of light that enters the at least one surface feature.

22. The interface device as defined in claim 21 wherein the light bending layer is further comprised of a low index of refraction material that directs light from a surface thereof into the at least one surface feature.

23. The interface device as defined in claim 22 wherein the low index of refraction material is further comprised of an aerogel.

24. The interface device as defined in claim 21 wherein the plurality of optical sensors is further comprised of an optical sensor that detects variation in light intensity delivered from the at least one surface feature, through the light guide, and to at least one of the plurality of optical sensors at at least one of the light detection points.

25. A method for displaying symbols and for receiving touch input from the interface device that functions as an optical display and optical touchpad, said method comprising the steps of:
(1) providing a light guide for directing light along a plurality of different light paths, at least one surface feature disposed in a surface of the light guide, wherein the surface feature enables light to enter and escape from the light guide, a light bending layer disposed against the surface of the light guide, for bending light that enters and exits the at least one surface feature, a plurality of light insertion points that enable light to be injected into the light guide, a plurality of light sources, one light source for each of the plurality of light insertion points, and a plurality of optical sensors, one optical sensor disposed at each of the light insertion points;
(2) operating in an optical display mode by sending a signal to at least one LED to transmit light along a selected light path to at least one surface feature, wherein the light exits the at least one surface feature and is bent by the light bending layer so as to travel outward perpendicular to a surface of the light bending layer.

26. The method as defined in claim 25 wherein the method is further comprised of the step of operating in an optical touchpad mode by detecting light at the optical sensors, wherein the light enters the light bending layer, passes through the at least one surface feature, travels through the light guide along a specific path to at least one of the plurality of optical sensors disposed at at least one of the plurality of light insertion points.
